(19) United States
(12) Patent Application Publication
(10) Pub. No.: US 2022/0171563 A1
(43) Pub. Date: Jun. 2, 2022

(54) Device for Monitoring the Status of Software Write Blocking

(71) Applicants: Steven Bress, Germantown, MD (US); Mark Joseph Menz, Folsom, CA (US)

(72) Inventors: Steven Bress, Germantown, MD (US); Mark Joseph Menz, Folsom, CA (US)

(21) Appl. No.: 17/107,906

(22) Filed: Nov. 30, 2020

(51) Int. Cl. G06F 3/06

(52) U.S. Cl. CPC G06F 3/0653; G06F 21/80; G06F 3/0605; G06F 3/0679

(57) ABSTRACT

A new device to determine the current Write Protection status of a Microsoft Windows system, referred to as BlokStat, has been invented. BlokStat provides current and accurate Write Protection status quickly to a user through a physical hardware device that is attached to a system and an associated application running on the system which monitors the status of the USB Write Protection entry in the system's registry. In general, the software application component queries the Microsoft Windows registry as to the current setting of the system Write Protection status. An indicator is then changed on the hardware module to indicate to a user the current system Write Protection status. Embodiments may include: means to gather and store data of BlockStat activities, means to verify the system Write Protection status, means to communicate with a user, such as email through Wi-Fi, and a plurality of different indicators and controllers.

### BACKGROUND OF THE INVENTION

### A. Field of the Invention

The present invention relates to digital memory storage, and, more specifically, to a device for monitoring the status of a Write Protection setting in Microsoft's Windows® Operating System registry.

### B. Description of Related Art

Write Protection is the ability of a hardware device or software program to prevent new information from being written or old information from being changed on a digital storage device.

U.S. Pat. No. 6,813,682 (hereinafter referred to as '682) teaches one method for hardware Write Protection. '682 teaches a hardware device that is placed between an operating system and a digital storage device. The benefits of '682 over software Write Protection is that '682 teaches secure Write Protection independently of any action performed by an Operating System. Software Write Protection depends on a registry setting which may be changed by a user or by an application. The benefit of software Write Protection is that it less expensive than hardware Write Protection and always available.

Microsoft Windows (hereinafter referred to as Windows) has a function that allows for the Write Protection of mass storage devices attached to a system's USB ports. Write Protection is used to make an attached storage device Read-Only, so that the data on the storage device will not be changed. This Write Protection function allows a user to examine the contents of a mass storage device without being able to change its contents. This has benefits for a number of fields, such as maintaining data security and performing computer forensics investigations.

The Write Protection function is controlled by a setting in the Windows Registry. Once the Write Protection setting is enabled, a USB storage device that is subsequently plugged in to the system will be write protected. When the Write Protection setting is disabled, all of the attached and subsequently attached USB storage devices may have their data changed.

A disadvantage of software Write Protection is that there is no feedback telling a User the actual current state of the Write Protection setting. While the user may have made a setting in the registry to enable the Write Protection function, there is no guarantee that a second application has not changed the setting. This can lead to the unfortunate situation where the user believes the system to be in one state while it is actually in another. In other words, you may have locked the front door of your house, but someone else in the house may have unlocked the front door without your knowledge.

A further disadvantage of software Write Protection is that enabling the Write Protection status of the system does not change the Write Protection status of any particular devices connected to the system at the time of the status change. The system registry keeps track of the Write Protection status of individual storage devices. The Write Protection system status determines what the Write Protection of an individual storage device is. This determination occurs when the storage device is connected to the system. Therefore, a storage device that is connected to the system with Write Protection disabled will not be write protected if the system Write Protection is changed to enabled. In this case, a storage device would have to be disconnected and then reconnected to the system for the storage device to be write protected.

Changing the system Write Protection status from enabled to disabled will change the status of individual storage devices connected to the system at the time of change. Changing the system Write Protection status from disabled to enabled will only change the status of individual storage devices connected to the system when said storage devices are disconnected from the system and subsequently reconnected. Currently, there are no methods to quickly indicate to a user the current system Write Protection status, that is, the Write Protection status a storage device will be set to when connected to the system. Additionally, there are no methods to quickly indicate to a user the current Write Protection status of an individual storage device connected to the system.

Although it is possible to indicate the Write Protection status using a dialog box in Windows, this is not the optimal solution for a couple of reasons. The first is that it takes screen space away from other applications. As it is typical for users to maximize the screen space for their primary application, another status window would likely be obscured. If one were to force the status window to be always on top, it would most likely obscure important ports of the active application. Therefore, there is a benefit to indicate to a user the Write Protection status of a system by a device independent of the operating system and its display.

As can be seen from the above discussion, there is a need in the art for methods to quickly indicate to a user the Write Protection status of a system and individual storage devices.

### SUMMARY

A new device to determine the current Write Protection status of a Windows system and quickly indicate to a user the current Write Protection status, referred to as BlokStat, has been invented. BlokStat provides current and accurate Write Protection status quickly to the user through a physical hardware device that is attached to a system and an associated application running on the system which monitors the status of the USB Write Protection entry in the system's registry.

In general, the software application component queries the Windows registry as to the current setting of the system Write Protection status. An indicator is then changed on the hardware module to indicate to a user the current system Write Protection status.

In an inexpensive embodiment, one LED may indicate the hardware component is connected to the system and recognized by the software module and a second multi-color LED may indicate whether system Write Protection is enabled or disabled.

More expensive embodiments may include one or more of the following:
means to gather and store data of BlockStat activities,
means to verify the system Write Protection status,
means to communicate with a user, such as Wi-Fi,
a plurality of indicators, such as, but not limited to, audio and external lighting.

BlokStat may be included in a second device such as a docking station or USB hub, which has the benefit of indicating to a user the Write Protection status of a system at the physical location a user may connect a storage device to the system.

Other technical advantages will be readily apparent to one skilled in the art from the following figures, descriptions and claims. Moreover, while specific advantages have been enumerated above, various embodiments may include all, some, or none of the enumerated advantages.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all of the disadvantages noted in the background.

### BRIEF DESCRIPTION OF THE DRAWINGS

The accompanying drawings, which are incorporated in and constitute a part of this specification, illustrate the invention and, together with the description, explain the invention. In the drawings,

FIG. 1 depicts a block diagram of one embodiment of the hardware device.

FIG. 2 depicts a block diagram of an embodiment of the hardware device incorporating a microprocessor.

FIG. 3 depicts a block diagram of an embodiment of the hardware device incorporating a microprocessor and data storage.

FIG. 4 depicts a block diagram of an embodiment of the hardware device incorporating a microprocessor, data logging capabilities, and communications capabilities.

FIG. 5 depicts one embodiment of the logic used by the software application.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

Embodiments of a BlokStat device can be implemented in a variety of ways. The following descriptions are of illustrative embodiments, and constitute examples of features in those illustrative embodiments, though other embodiments are not limited to the particular illustrative features described.

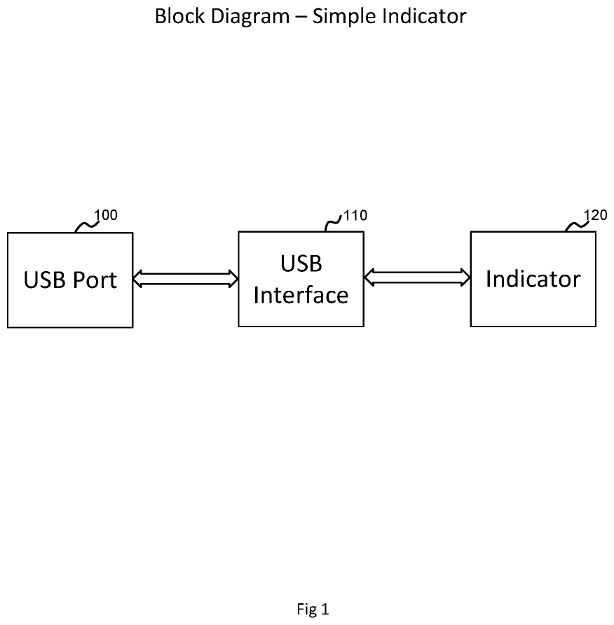

In general, BlokStat comprises two components. One, an application running on a Windows system; two, a hardware device connected to the system. FIG. 1 is a block diagram of an inexpensive embodiment of the hardware device. USB Port 100 connects the hardware to the Host computer. USB Interface 110 connects the USB Port 100 to indicator 120. Indicator 120 may be a visual indicator such as an LED. USB Interface 110 may be an inexpensive USB to Serial chip, such as FTDI's FT230X. In this embodiment, the application running on the Windows system may use system controllable control lines to change the status of one or more LEDs. In one embodiment, the LED may be a multi-color LED. In this case, the status of the LED may be, green indicates Write Protection status is enabled and red indicates Write Protection status is disabled. USB Interface 110 has a unique identifier which may be queried by the system.

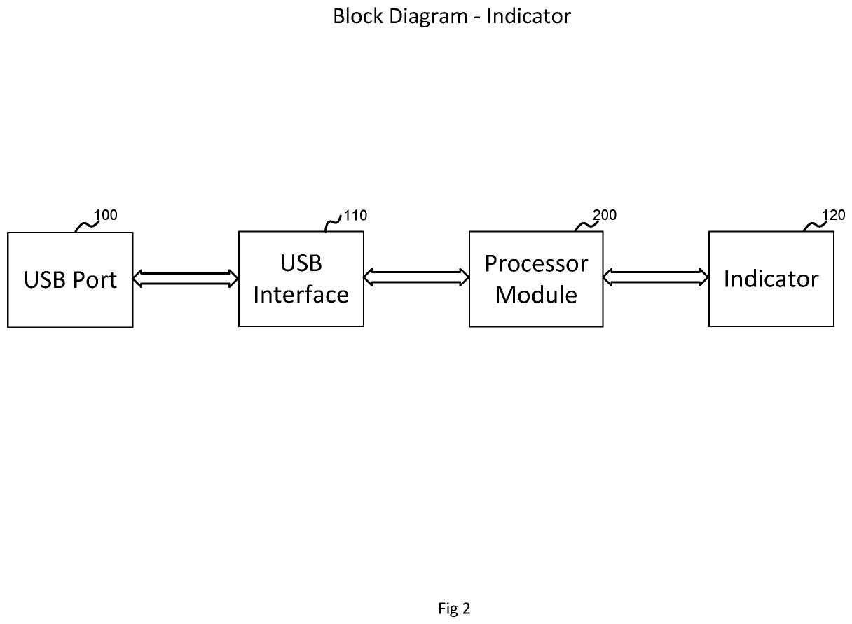

FIG. 2 is a block diagram of a more complex embodiment of the hardware device in FIG. 1. In this embodiment, USB Interface 110 connects to a microcontroller 200. Microcontroller 200 is connected to Indicator 120. USB Interface 110 and microcontroller 200 may be two separate chips such as FTDI's FT230X and Microchip's PIC16LF1554, or the functionality may be contained in one chip such as Cypress Semiconductor's CY8C5868LTI. In these embodiments there is no functional difference, but a two chip embodiment may be less expensive to manufacture.

This embodiment incorporates a microprocessor to allow for more flexibility. Incorporating a microprocessor allows this embodiment to use a plurality of Indicators and a plurality of Indicator states. For example, one embodiment may include two LED lights and an audio speaker. In this embodiment, one LED light may indicate that the device is connected to a system, the second LED light may indicate the system Write Protection status and the audio speaker may give an audio alert when the system Write Protection status changes.

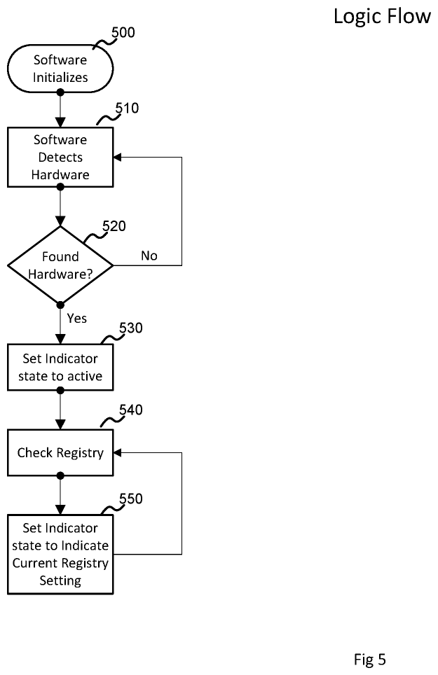

FIG. 5 illustrates one simple embodiment of the logic flow of the software application component for the hardware embodiment of FIG. 2. The Windows application component of BlockStat is initialized 500 either by a user or automatically by the system. The application then searches for the IDs of USB devices connected to the system 510. If an ID of an approved hardware component is not identified 520, the application searches for additional IDs 510. If an ID of an approved hardware component is identified 520, an indicator status is changed to inform a user that the software and hardware components are communicating 530.

Once the connection between the hardware and software has been established, the system registry is queried 540 to determine the current state of the system Write Protection setting. The application changes the status of the Indicator to reflect the current system Write Protection setting 550. Control passes back to the system registry query 540.

One knowledgeable in the art would understand that the logic flow of FIG. 5 is the simplest logic flow to enable BlokStat to function. For example, it may be advantageous for the software component to additionally confirm that the hardware component is currently connected to the system on random or pre-determined intervals.

### OPERATIONAL EXAMPLE

The following discussion involves one embodiment of BlokStat and is intended to illustrate, but not limit, the current invention. The following discussion generally refers to the hardware component described in FIG. 2 and the logic flow as illustrated in FIG. 5.

A common method to examine a SATA drive is to use an external docking station that connects to a system through a USB port and provides a SATA interface for the drive. In some cases, the external docking station may provide additional USB ports for connecting one or more additional devices. In this case, the docking station internally contains a USB hub, allowing for both the SATA drive and additional USB device ports to be used simultaneously.

In an embodiment of a docking station with additional USB ports, the hardware component of BlokStat may be plugged into the docking station's USB device port. A device port typically provides power to a device and connectivity to the Host. In another embodiment, a docking station may be manufactured with the hardware component of the present invention built in.

With the BlockStat Application component running on a Host which can be connected to the docking station, a user may use the Application to set the system Write Protection status setting to Enabled. If the user has not already done so, a SATA drive may be installed into the docking station and power supplied, if required. The docking station's USB cable may then be connected to the Host system. The BlockStat Application would detect that the hardware component is available for communication and set an indicator LED to show a status of “Connected.” Now that communication between the Application and its associated hardware has been established, the Application checks the registry for the current state of the Write Protection setting. If the state is “Protected”, the Application would then update an indicator to show the “Protected” state. Otherwise the indicator would show a state of “Not-Protected.”

The Application periodically checks the system registry for changes in the System Write Protection Status and updates an indicator to reflect the current state of protection in the system. While the status is Protected, the system should not allow the data on the SATA drive to be modified. While Protected, the User could use an appropriate computer forensics application to examine the contents of the SATA drive.

### Additional Embodiments

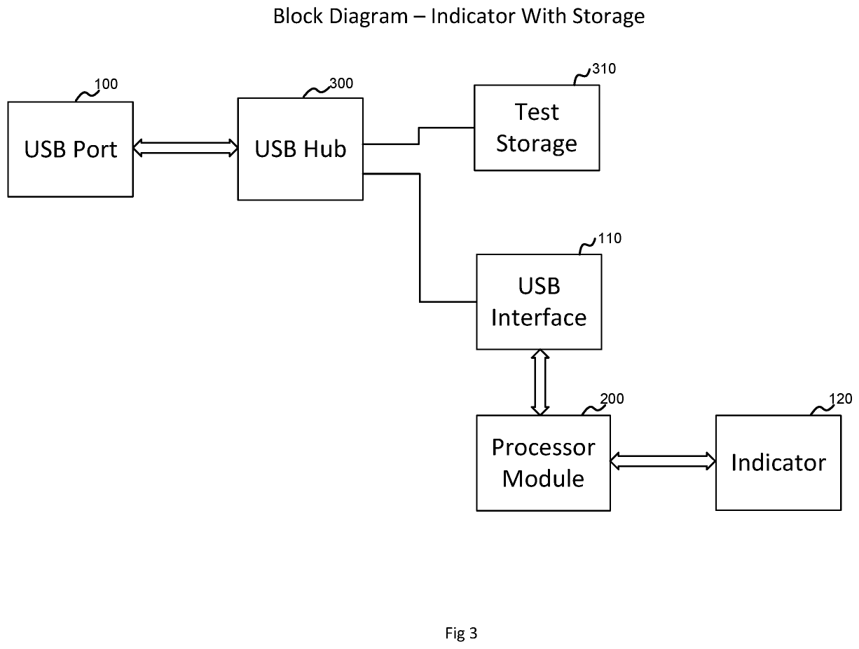

FIG. 3 illustrates a more complex, and therefore more expensive to manufacture, embodiment of the BlokStat hardware component of FIG. 2. This embodiment allows the Application component to perform an actual read/write test. In order not to change any data on a host or on a drive that is being forensically examined, a mass storage device is contained in the hardware component.

In this embodiment a USB hub 300 is connected to the USB port 100. USB mass storage device 310 connected to one port of 300. Connected to the other port of USB hub 300 is the circuit from the embodiment illustrated in FIG. 2.

In this embodiment, the BlokStat hardware component enumerates to a Host that it is also a Mass Storage device. Test Storage 310 may consist of processor module 200 using its internal memory to create a small solid state disk or it may consist of external memory to create a storage device of the desired size.

The BlokStat Application may include additional logic to attempt to write data to Test Storage 310. The Application would additionally have logic to determine if data on 310 has changed. If data has changed, then it may indicate to the user that system Write Protection may not be currently active. If the Application continues to be able to write to 310, it may indicate to a user that the Host system may have been compromised in some fashion and should not be used to forensically review data.

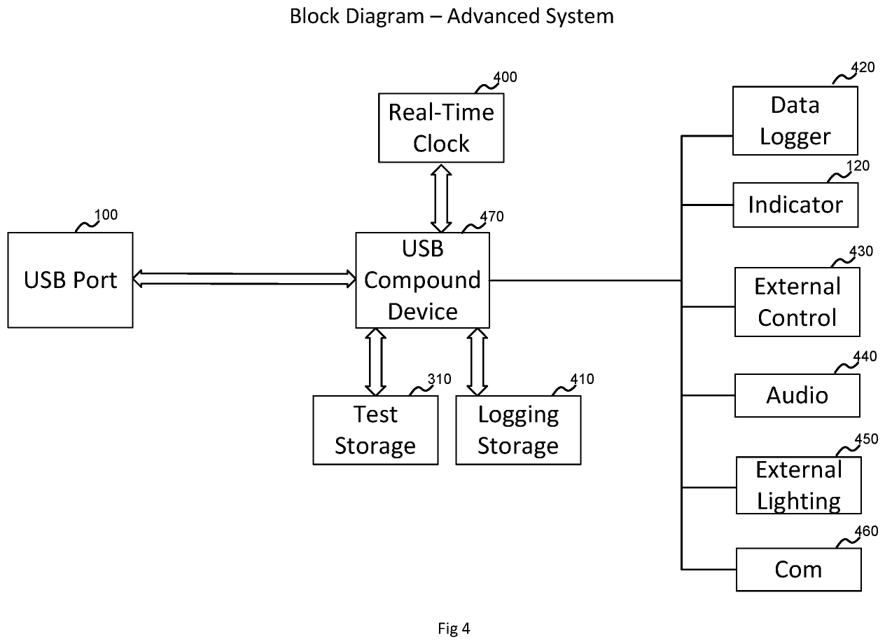

FIG. 4 illustrates an embodiment of BlokStat with additional functionality. A Real-Time Clock 400 is designed in so that Processor 470 may have a time/date reference separate from the Host computer. Processor 470 has an embedded USB interface. Additional long term storage 410 is used keep a log of events, including but not limited to, time and date of a change to the system Write Protection status. The embodiment illustrated in FIG. 4 may appear similar to the embodiment illustration in FIG. 3, one major difference is that there is no USB hub. In this case the Processor Module 470 responds as a USB Compound Device to a Host computer. A compound device can respond as multiple types of USB devices using a single port. A common example would be a USB connected keyboard that implements both keyboard and mouse functions through a single cable. Processor module 470 is more expensive than Processor Module 200.

One knowledgeable in the art would understand that using Processor 470 is only one method to accomplish the functionality described in FIG. 4. In another embodiment the functionality of 470 would be accomplished by having a USB hub connected to USB Port 100. The Test Storage 310 would connect directly to the hub, as would Processor Module 470. Processor Module 470 could also read and control some or all of the other peripherals as detailed in FIG. 4. Should it be advantageous to do so, one or more of the other peripherals may be connected to the USB hub rather than Processor Module 470.

External interface 420 is provided for the data logging feature so that data may be exported. A removable SD card may be used as storage for the logged information.

External Control 430 is an interface for other types of real world devices, such as spinning warning lights or other peripherals. There are a number of different ways that this might be implemented, but a simple solution would be a relay switch closure, so that it could control both low and high powered devices.

An Audio interface 440 is provided in order to provide auditory feedback as to the state of Write Protection.

An external lighting interface 450 is provided so that additional lighting and even specialty lighting, such as LED strips, may be used for status and warning indications.

A communications interface 460 is provided so that BlokStat may pass information to other devices. In a simple embodiment, this may be used to print data from the logged information. In an embodiment where the communications interface uses a wireless protocol, such as Wi-Fi, BlokStat may send an email or text as to the state of Write Protection to a user. One knowledgeable in the art would understand that there are a variety of embodiments, both wired and wireless, to communicate the state of Write Protection to a user.

One embodiment involves the addition of a Real Time Clock 400 to the Processor Module 470. This is typically battery backed so that the clock continues to run when power has been disconnected. With the ability to know the time and date, the Processor Module may also be used to control memory for a data logging function. Data logging may allow the device to keep a record of the time and date of changes to the Write Protection setting of the Host computer, as well as the date and time of the device being powered on. With additional modifications, the device may also keep a record of when it was powered down.

This can provide independent verification of the procedure used to secure the data on a drive under examination. One of the options for this embodiment is to store the data logging files on a removable storage device such as an SD card.

In addition to indicating the Write Protection status with simple lights, a user may want a more aggressive type of display. For instance, a spinning red security light may be used to indicate a “Write Protection disabled” state. To this end, an External Control 430 may be implemented. This can take the form of an external connection that produces a switch closure. This can be implemented using a relay or other appropriate physical or electronic switching mechanisms. This feature can be used to control AC or DC devices as desired. Multiple switch closure ports may be implemented, if desired.

External Lighting 450 allows for the connection of external specialty lighting, such as an LED strip. This interface may generate the signals and timing that allows the BlokStat Application to set colors and patterns in an attached LED strip.

In another embodiment a communication protocol is implemented, such as Wi-Fi 460. Through this port, BlokStat would gain the ability to notify a user of important events, such as a change in Write Protection status, using a protocol such as email or text messaging. With additional circuitry and a dedicated power source, such as a battery, BlokStat could also notify a User that a power failure has occurred. Examining drives typically takes a significant amount of time, and it is not uncommon for a User to wander away during the process.

In a further embodiment, additional logic and circuitry in the hardware component may allow a user to request a change to the system Write Protection status from the hardware component.

It will be apparent to one of ordinary skill in the art that the embodiments as described above may be implemented in many different forms of software, firmware, and hardware in the embodiments illustrated in the figures. The actual software code or specialized control hardware used to implement aspects consistent with the present invention is not limiting of the present invention. Thus, the operation and behavior of the embodiments were described without specific reference to the specific software code, it being understood that a person of ordinary skill in the art would be able to design software and control hardware to implement the embodiments based on the description herein.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed:

1. A device to determine the current write Pprotection status of a Microsoft Windows system and indicate said status to a user comprising:
a hardware component comprising:
a. a USB port,
b. a USB interface connected to the USB port,
c. one or more indicators connected to the USB interface, and
a software application component configured to operate on a Microsoft Windows system comprising the steps of:
a. identifying the hardware component,
b. querying the Microsoft Windows system registry on the state of the system write protection status,
c. changing the status of an indicator of the hardware component to indicate the current state of the system Write Protection status.

2. The device to determine the current write protection status of a Microsoft Windows system and indicate said status to a user of claim one, wherein the software application component further comprises the step of:
changing the status of an indicator of the hardware component to indicate the hardware component has been identified.

3. The device to determine the current write protection status of a Microsoft Windows system and indicate said status to a user of claim one, wherein the hardware component further comprises:
a microprocessor connected between the USB interface and one or more indicators.

4. The device to determine the current write protection status of a Microsoft Windows system and indicate said status to a user of claim three, wherein the hardware component further comprises:
a USB hub connected between the USB port and the USB interface, and
mass digital storage connected to the USB hub.

5. The device to determine the current write protection status of a Microsoft Windows system and indicate said status to a user of claim four, wherein the software component additionally comprises the steps of:
initiating a command to change the state of the data on the mass digital storage device of the hardware component,
determining if the data on the mass digital storage device of the hardware component has been changed,
changing the status of an indicator of the hardware component to indicate if the data has been changed.

6. A device to determine the current write protection status of a Microsoft Windows system and indicate said status to a user comprising:
a hardware component comprising:
a. a USB port,
b. a USB compound device connected to the USB port,
c. data storage connected to the USB compound device, configured to store test data
d. data storage connected to the USB compound device, configured to store logging data
e. one or more indicators connected to the USB compound device, and
a software application component configured to operate on a Microsoft Windows system comprising the steps of:
a. identifying the hardware component,
b. querying the Microsoft Windows system registry on the state of the system Write Protection status,
c. changing the status of an indicator of the hardware component to indicate the current state of the system Write Protection status.
d. changing the status of an indicator of the hardware component to indicate the hardware component has been identified
e. initiating a command to change the status of the test data on the mass digital storage device of the hardware component,
f. determining if the test data on the mass digital storage device of the hardware component has been changed,
g. changing the status of an indicator of the hardware component to indicate if the test data has been changed.

7. The device to determine the current write protection status of a Microsoft Windows system and indicate said status to a user of claim six, further comprising:
a real time clock connected to the USB compound device.
